(19) United States
(12) Patent Application Publication
(10) Pub. No.: US 2015/0336424 A1
(43) Pub. Date: Nov. 26, 2015

(54) REINFORCED LIGHTWEIGHT TIRE

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventor: Herve FERIGO, Clermont-Ferrand (FR)

(21) Appl. No.: 14/377,325

(22) PCT Filed: Feb. 8, 2013
(86) PCT No.: PCT/EP2013/052575

§ 371 Date: Aug. 7, 2014

Related U.S. Application Data
(60) Provisional application No. 61/660,078, filed on Jun. 15, 2012.

(30) Foreign Application Priority Data
Feb. 10, 2012 (FR) 1251279

(51) Int. Cl. B60C 3/04; B60C 5/00; B60C 15/00

(52) U.S. Cl. CPC B60C 3/04; B60C 15/00; B60C 5/00

(57) ABSTRACT

Tire with a maximum axial width SW and axial width RW at the beads, comprising a crown reinforcement of width TW and a radial carcass reinforcement, in which Tire, when it is fitted onto its mounting rim and inflated to its service pressure and equilibrium, the following conditions are satisfied: TW/SW≦75%, TW/RW≦85% and X/SH≦50%, where X is the radial height at which the Tire has its maximum axial width and SH denotes the radial height of the Tire; Y/SH≧80%, where Y is the radial height of the carcass reinforcement at the end of the crown reinforcement; and Z/SH≧90%, where Z denotes the radial height of the carcass reinforcement, wherein the absolute value of the angle α between the tangent to the carcass reinforcement at the points on the carcass reinforcement having the same axial positions as the axial ends of the crown reinforcement and the axial direction is less than or equal to 22°, and wherein each of the sidewalls comprises at least two crossed reinforcing members.

This application is a 371 national phase entry of PCT/EP2013/052575, filed 8 Feb. 2013, which claims benefit of FR 1251279, filed 10 Feb. 2012 and of U.S. provisional application Ser. No. 61/660,078, filed 15 Jun. 2012, the entire contents of each of which are incorporated herein by reference for all purposes.

### BACKGROUND

1. Field

The present disclosure relates to the radial tires for land vehicles and more particularly to radial tires for passenger vehicles. The disclosure relates more particularly to lightweight tires and to the arrangements suitable for increasing the resistance of these tires to the damage to which they are exposed when they hit obstacles on the ground, such as pavements or potholes.

2. Description of Related Art

Research on tires serving to reduce the energy consumption of a vehicle is presently gaining momentum. Among the promising approaches explored by tire designers, mention may be made of reducing the rolling resistance of tires, especially by the use of low-hysteresis materials, but also reducing the tire weight. It has been proposed to reduce the tire weight by reducing the thicknesses of material and the densities of the reinforcing elements (use of textile cords) or of the rubber compounds, or by using reinforcing elements which allow reduction of certain volumes of inner liner compounds, for example in the region of the bead. Such tires are described for example in U.S. Pat. No. 6,082,423 and in the documents cited therein.

Another way of reducing the tire mass involves generally reducing its dimensions. Of course, such a reduction is not without consequence on the service capability of the tire. The International standards, such as those of the ETRTO or JATMA define, for each nominal dimension, the physical dimensions of the tire, such as its sectional height and its sectional width when fitted onto a rim of given diameter and width. At the same time, they define a “loading capacity” of the tire, that is to say, the maximum admissible static load on a wheel of the vehicle at a given service pressure.

In such standards, the load capacities are deduced from the nominal dimensions using semi-empirical relationships. These relationships set a maximum static deflection for a tire, normalized by its dimensions, and are based on a standard geometry of the section profiles of the tires of the current technology. They predict that the loading capacity of tires of course decreases when, all other things being equal, the section height or width decreases.

A reduction in the dimensions of a tire is of course not without consequence with respect to the serviceability of the tire, its wear lifetime and the endurance of its structure for a given service load on a wheel of the vehicle.

However, these standards leave the designer with certain degrees of freedom regarding the dimensions of the section profile that it is possible to use in the context of reducing the mass and rolling resistance of a tire. Most of the mass of a tire and most of its rolling resistance result from the region of its crown. Reducing the width of the crown would therefore result in an almost proportional increase in the contribution of the crown to the mass and, as experience has shown, an increase in its contribution to rolling resistance.

When a tire is rolling on the ground under normal use conditions (in terms of speed and load), it may be subjected to shocks on the tread or sidewalls, the frequency and intensity of which are often considerable. It is one of the main functions of a tire that it should absorb these shocks and damp them without the vehicle's wheel in question being substantially affected thereby, either in its movement or in its integrity.

However, it happens that this absorption capability encounters its limits when the impact conditions are such that the sidewall of the tire impacted comes into abutment inside the air chamber either directly with the rim, on which the tire is mounted, or more usually on another region of the sidewall of the tire itself, directly bearing on the wheel rim. This is especially the case when the rim has an external radial projection relative to the actual seat. Such a projection (usually called a “rim flange”) is in general provided for preventing the tire bead from coming off the rim due to the effect of axially directed stresses during wheel manoeuvres.

The impact with an obstacle can then transfer brief, but very intense loads, possibly in certain cases reaching several tons, on the abutted parts but also, beyond the rim, on the mechanical suspension attachments for the wheel assembly, or even on the body of the vehicle. They are capable of creating serious damage on the suspension members and of permanently deforming the vehicle body. Vehicle designers therefore have to provide sufficient damping systems to prevent this damage and to design vehicle bodies in accordance with normally predictable extreme situations.

Unfortunately, even when the vehicle is, strictly speaking, suitably protected, the tire subjected to this type of incident is liable to seriously suffer the consequences of the abovementioned phenomenon. In the section impacted by the shock, the internal wall of the tire is suddenly folded and pinched between the obstacle and the rim flange. This may cause the wall to rupture and the tire to suddenly lose its inflation pressure, which usually means that the vehicle is immediately immobilized. However, even when the tire withstands this impact, it is often found that its components have been damaged by the incident: indentations in the sidewalls or other signs indicate to a tire expert that the structure of the tire has been weakened and that its sidewall runs the risk of rupturing under the effect of its components being repeatedly flexed, in the relative long term, which would of course be incompatible with the conditions necessary for safe driving.

It turns out that lightweight tires of small dimensions are particularly vulnerable to this type of damage.

### SUMMARY

The objective of embodiments of the present invention is to address these concerns and to reduce the risks incurred by a lightweight tire when it is faced with the shock of contact with obstacles on a roadway, for example when encountering a pothole or a pavement.

This objective is achieved, in an embodiment, by a tire having a rotation axis and comprising:

two beads intended to come into contact with a mounting rim, each bead comprising at least one annular reinforcing structure, defining a mid-plane which is perpendicular to the rotation axis of the tire and located equidistant from the annular reinforcing structures of each bead, the annular reinforcing structures having, in any radial cross section, a radially innermost point;

two sidewalls extending the beads radially outwards, the two sidewalls joining in a crown comprising a crown reinforcement, having two axial ends, said crown reinforcement being surmounted by a tread;

at least one carcass reinforcement extending from the beads through the sidewalls as far as the crown, the carcass reinforcement comprising a plurality of radially oriented carcass reinforcement elements and being anchored in the two beads by an upturn around the annular reinforcing structure, so as to form an main portion and a wrapped-around portion of the carcass reinforcement,

wherein, when the tire is fitted onto the mounting rim and inflated to its service pressure:

the tire has a maximum axial width SW such that the ratio TW/SW≦75% (and preferably TW/SW≦73%), where TW denotes the axial distance between the two axial ends of the crown reinforcement, the maximum axial width SW being reached at a radial distance X from the radially innermost point of the annular reinforcing structures;

the axial distance RW of the two points of intersection of the axial direction passing through the radially innermost point of the annular reinforcing structures with the external surface of the tire is such that TW/RW≦85% (and preferably TW/RW≦83%);

the tire satisfies the following three conditions: X/SH≦50%, Y/SH≧80% and Z/SH≧90%, where SH denotes the distance between the radially outermost point of the tire and the radially innermost point of the annular reinforcing structures, Y denotes the radial distance between (i) the points on the carcass reinforcement having the same axial positions as the axial ends of the crown reinforcement and (ii) the radially innermost point of the annular reinforcing structures, and Z denotes the radial distance between the radially outermost point of the carcass reinforcement and the radially innermost point of the annular reinforcing structures;

the absolute value of the angle α (alpha) between the tangent to the carcass reinforcement at the points on the carcass reinforcement having the same axial positions as the axial ends of the crown reinforcement and the axial direction is less than or equal to 22°; and

at any point on the carcass reinforcement, the radius of curvature ρ is such that

$$ρ = \frac{{R}_{S}^{2} - {R}_{E}^{2}}{2 R} ,$$

where R_{S} is the radial distance between the rotation axis of the tire and the radially outermost point of the carcass reinforcement, R_{E} is the radial distance between the rotation axis of the tire and the axial position where the tire reaches its maximum axial width SW, and R is the radial distance between the rotation axis of the tire and the point in question on the carcass reinforcement;

wherein each sidewall of the tire comprises a first reinforcing member and a second reinforcing member, the first reinforcing member being reinforced by reinforcement elements placed parallel to one another, making an angle β (beta) of between 10° and 90° with the circumferential direction, the second reinforcing member being reinforced by reinforcement elements parallel to one another, making an angle γ (gamma) of −β with the circumferential direction; and

wherein the first and second reinforcing members extend along the carcass reinforcement, between a radially inner end and a radially outer end, the radial distance of each of the radially inner ends from the radially innermost point of the annular reinforcing structure being less than 10% of the distance SH, and the radial distance of each of the radially outer ends from the radially innermost point of the annular reinforcing structure being greater than 30% of the distance SH.

In a particular embodiment, the reinforcement elements that reinforce the first reinforcing member and the second reinforcing member may desirably be filamentary reinforcement elements, but it is also possible to use flat reinforcement elements such as, for example, strips made of thermoplastic material. In this situation, the angles are understood to mean with respect to the longitudinal direction of the strips.

According to a first preferred embodiment, the first reinforcing member is placed axially inside the main portion of the carcass reinforcement and the second reinforcing member is placed axially outside the main portion of the carcass reinforcement and axially inside the wrapped-around portion of the carcass reinforcement, e.g., over the height of the wrapped-around portion of the carcass reinforcement or some portion thereof. This embodiment makes it possible to minimize the thickness of the “inner liner” impermeable to the inflation gas, which covers the internal surface of the tire. It also makes it possible to control the torsional stiffness of the tire and, consequently, its cornering stiffness.

According to a second preferred embodiment, the first and second reinforcing members are placed axially outside the main portion of the carcass reinforcement and axially inside the wrapped-around portion of the carcass reinforcement, e.g., over the height of the wrapped-around portion of the carcass reinforcement, or some portion thereof. This embodiment makes it possible for the “bead filler” volume, that is to say the portion of rubber composition filling the volume between the main portion and the wrapped-around portion of the carcass reinforcement, to be very significantly reduced and for the stiffness of this region of the tire to be modified by varying the angle of the reinforcement elements.

According to one particular embodiment, the radial distance of each of the radially outer ends of the reinforcing members from the radially innermost point of the annular reinforcing structure is greater than 80% of the distance SH. According to one particularly advantageous variant of this embodiment, the radially outer ends of the reinforcing members are axially inside the axial ends of the crown reinforcement. This embodiment makes it possible to control the torsional stiffness of the tire and, consequently, its drift resistance. It also makes the tire more robust with respect to perforations of the sidewall.

Preferably, in a particular embodiment the tire has only a single carcass reinforcement so as to reduce its weight.

The invention, in embodiments, also relates to an assembly formed by a mounting rim and a tire as described above.

### BRIEF DESCRIPTION OF THE DRAWINGS

FIG. 1 shows a tire according to the prior art.

FIG. 2 shows a partial perspective view of a tire according to the prior art.

FIG. 3 shows, in radial section, one half of a reference tire.

FIG. 4 shows part of the tire of FIG. 3.

FIG. 5 illustrates the parameters used to describe an inflated carcass reinforcement in equilibrium.

FIGS. 6 to 8 show, in radial section, a portion of a tire according to embodiments of the invention.

### DETAILED DESCRIPTION OF SPECIFIC EMBODIMENTS

When employing the term “radial”, a distinction should be made between several different uses of the word by those skilled in the art. Firstly, the expression refers to a radius of the tire. It is in this sense that a point P1 is said to be “radially inside” a point P2 (or “radially to the inside” of point P2) if it is closer to the rotation axis of the tire than point P2. Conversely, a point P3 is said to be “radially outside” a point P4 (or “radially to the outside” of point P4) when it is further away from the rotation axis of the tire than point P4. The expression “radially inwardly (or outwardly)” means going towards smaller (or larger) radii. When distances are referred to as radial distances, this meaning of the term also applies.

However, a thread or a reinforcement is said to be “radial” when the thread or reinforcing elements of the reinforcement make an angle of not less than 80° but not exceeding 90° with the circumferential direction. It should be pointed out, that in the present document, the term “thread” should be understood in a very general sense and comprises threads in the form of monofilaments, multifilaments, a cord, a folded yarn or an equivalent assembly, irrespective of the material constituting the thread or the surface treatment for promoting adhesion to the rubber.

Finally, the term “radial section” or “radial cross section” is understood here to mean a section or cross section in a plane that contains the rotation axis of the tire.

An “axial” direction is a direction parallel to the rotation axis of the tire. A point P5 is said to be “axially inside” a point P6 (or “axially to the inside” of point P6) if it is closer to the mid-plane of the tire than point P6. Conversely, a point P7 is said to be “axially outside” a point P8) or “axially to the outside” of point P8) if it is further away from the mid-plane of the tire than point P8. The “mid-plane” of the tire is the plane which is perpendicular to the rotation axis of the tire and located equidistant from the annular reinforcing structures of each bead. When it is said that the mid-plane separates, in any radial section, the tire into two tire “halves”, this does not mean that the mid-plane necessarily constitutes a plane of symmetry of the tire. The expression “tire half” has here a broader meaning and denotes a portion of the tire having an axial width close to one half of the axial width of the tire.

A “circumferential” direction is a direction perpendicular both to a radius of the tire and to the axial direction.

In the context of this document, the expression “rubber compound” denotes a rubber compound comprising at least one elastomer and at least one filler.

The “external surface” of the tire denotes here the surface of the tire which is intended to be in contact with the atmosphere (or with the mounting rim), as opposite to its internal surface, which is intended to be in contact with the inflation gas.

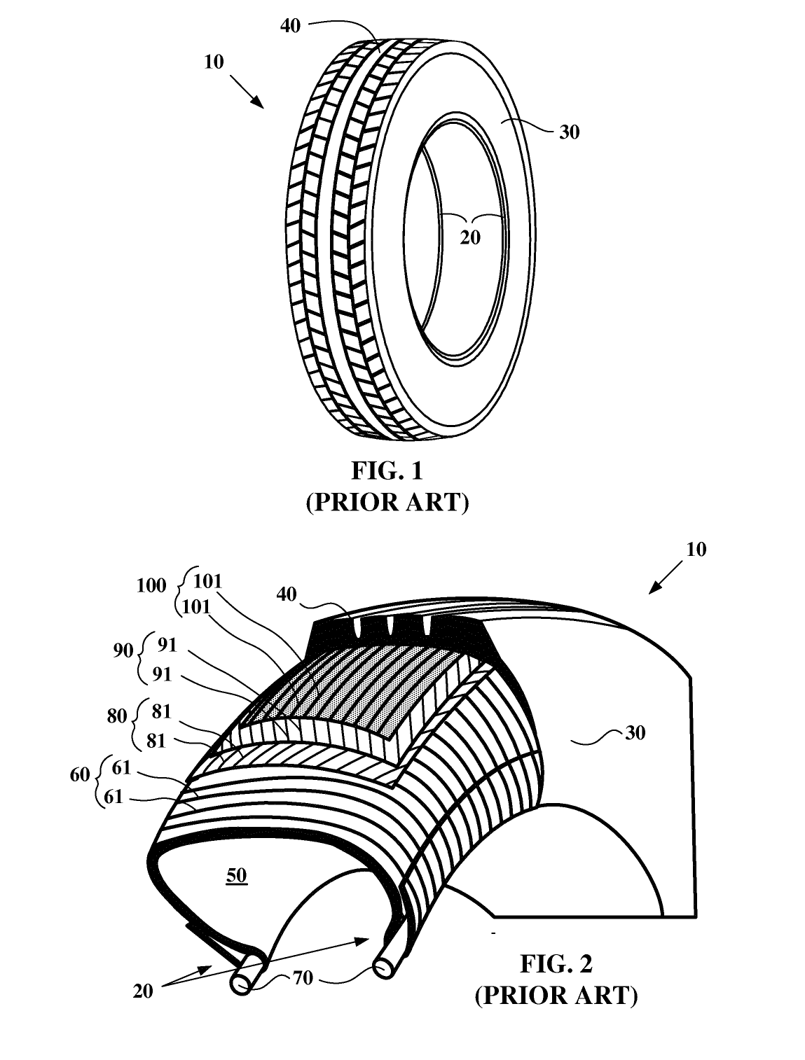

FIG. 1 shows schematically a tire 10 according to the prior art. The tire 10 comprises a crown, having a crown reinforcement (not visible in FIG. 1) surmounted by a tread 40, two sidewalls 30 extending the crown radially inwards, and two beads 20 radially inside the sidewalls 30.

FIG. 2 shows schematically a partial perspective view of a tire 10 according to the prior art and illustrates the various components of such a tire. The tire 10 comprises a carcass reinforcement 60 consisting of threads 61 embedded in a rubber composition, and two beads 20 each comprising annular reinforcing structures 70 which hold the tire 10 on the rim of the wheel (not shown). The carcass reinforcement 60 is anchored in each of the beads 20 by an upturn. The tire 10 further includes a crown reinforcement comprising two plies 80 and 90. Each of the plies 80 and 90 is reinforced by filamentary reinforcing elements 81 and 91 which are parallel in each ply and crossed from one layer to the next, making angles of between 10° and 70° to the circumferential direction. The tire further includes a hooping reinforcement 100 placed radially outside the crown reinforcement, this hooping reinforcement being formed from circumferentially oriented reinforcing elements 101 wound in a spiral. A tread 40 is placed on the hooping reinforcement; it is via this tread 40 that the tire 10 comes into contact with the road. The tire 10 shown is a “tubeless” tire: it includes an “inner liner” 50 made of a butyl-based rubber composition impermeable to the inflation gas and covering the internal surface of the tire.

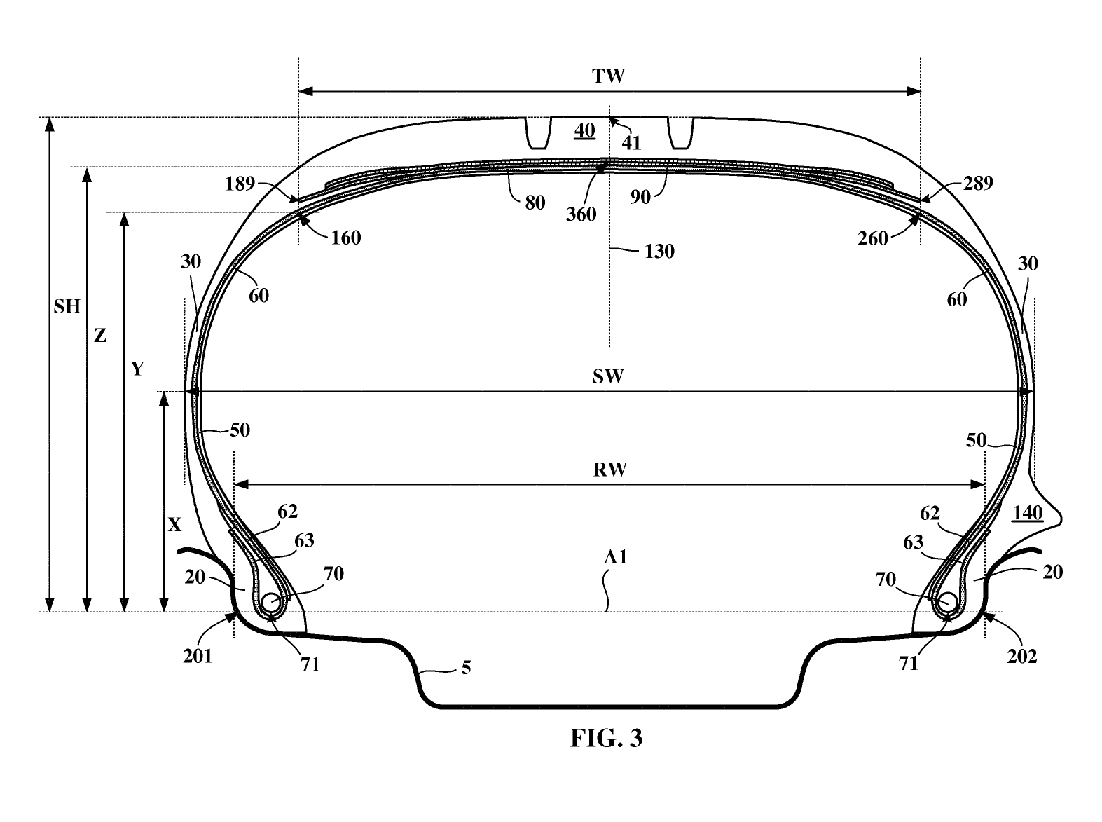

FIG. 3 shows, in radial cross section, one half of a reference tire. This tire has a rotation axis (not shown) and comprises two beads 20 intended to come into contact with a mounting rim 5. Each bead has an annular reinforcing structure, in this case a bead wire 70. Here, the two bead wires 70 have the same diameter and there are two points 71 corresponding to the radially innermost point of the bead wires 70.

The tire has two sidewalls 30 extending the beads radially towards the outside, the two sidewalls 30 joining in a crown having a crown reinforcement formed by the plies 80 and 90. The crown reinforcement has two axial ends 189 and 289. In the illustrated embodiment, these ends coincide with the axial ends of the radially inner ply 80, but it is also perfectly possible to provide a radially outer ply 90 that extends axially beyond the inner ply, on only one side of the mid-plane 130, or on each side of this plane, without departing from the scope of the invention. The crown reinforcement is surmounted by a tread 40. In principle, it would be possible also to provide a hooping reinforcement, such as the hooping reinforcement 100 of the tire shown in FIG. 2, but in the present case the aim was to minimize the weight of the tire by not providing a hooping reinforcement.

The tire comprises a single radial carcass reinforcement 60 extending from the beads 20 through the sidewalls 30 to the crown, the carcass reinforcement 60 comprising a plurality of carcass reinforcing elements. It is anchored in the two beads 20 by an upturn around the bead wire 70, so as to form a main portion 62 and a wrapped-around portion 63.

When the tire is fitted onto the mounting rim 5 and inflated to its service pressure, it meets several criteria.

Firstly, it has a maximum axial width SW such that the ratio TW/SW≦75%, where TW denotes the axial width of the crown reinforcement, i.e. the axial distance between the two axial ends 189 and 289 of the crown reinforcement. In the embodiment illustrated, TW/SW=73%, and in a more particular embodiment, TW/SW≦73%. The maximum axial width SW is reached at a radial distance X from the radially innermost point of the annular reinforcing structures. It should be pointed out that when determining the width SW, no account is taken of excrescences such as the protective bead 140.

Secondly, the axial distance RW of the two points of intersection 201 and 202 of the axial direction A1 passing through the radially innermost point(s) 71 of the bead wires 70 with the external surface of the tire is such that TW/RW≦85%. In the embodiment illustrated TW/RW=83%, and in a more particular embodiment, TW/RW≦83%.

Thirdly, X/SH≦50% (and preferably, X/SH≦45%), where SH denotes the distance between the radially outermost point 41 of the tire, and the radially innermost point 71 of the annular reinforcing structures 70. In the embodiment illustrated, X/SH=50%.

Fourthly, Y/SH≧80%, where Y denotes the radial distance between (i) the points 160 and 260 of the carcass reinforcement 60 having the same axial positions as the axial ends 189 and 289 of the crown reinforcement and (ii) the radially innermost point 71 of the annular reinforcing structures 70, SH being defined as above. In the embodiment illustrated, Y/SH=80%. When the carcass reinforcement 60 has a significant width, Y should be taken at the neutral fibre of the reinforcement elements 61 constituting it. In a more particular embodiment, Y/SH≧90%.

Fifthly, Z/SH≧90%, where Z denotes the radial distance between the radially outermost point 360 of the carcass reinforcement 60 and the radially innermost point 71 of the annular reinforcing structures 70, SH being defined as above. In embodiment illustrated, Z/SH=90%.

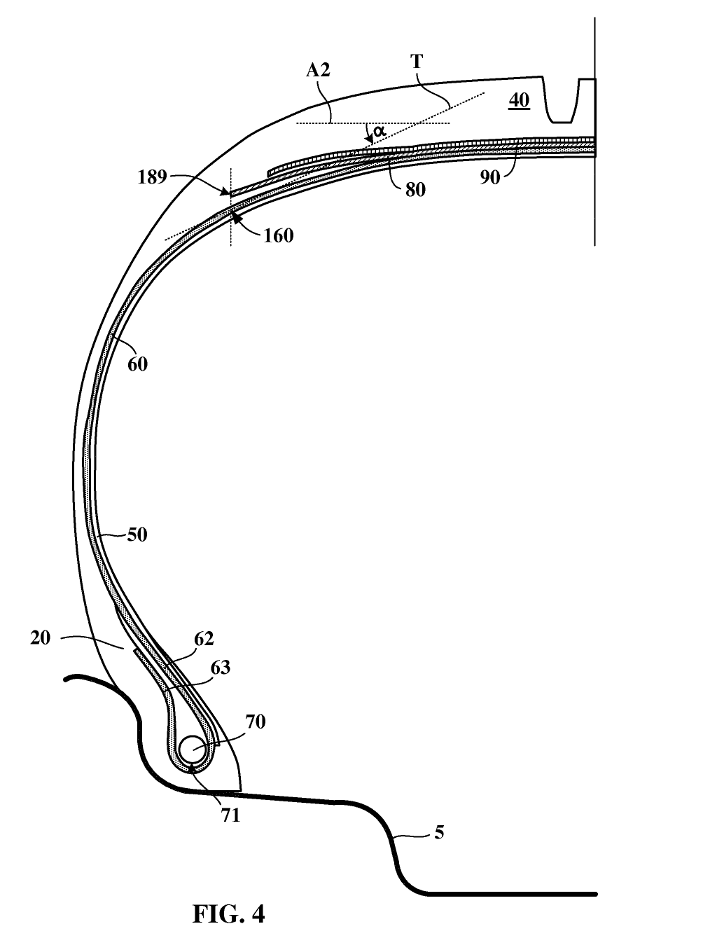

Sixthly, the absolute value of the angle α (alpha)—indicated in FIG. 4, between the tangent T to the carcass reinforcement 60 at the points 160 and 260 of the carcass reinforcement 60 having the same axial positions as the axial end points 189 and 289 of the crown reinforcement and the axial direction, is less than or equal to 22°.

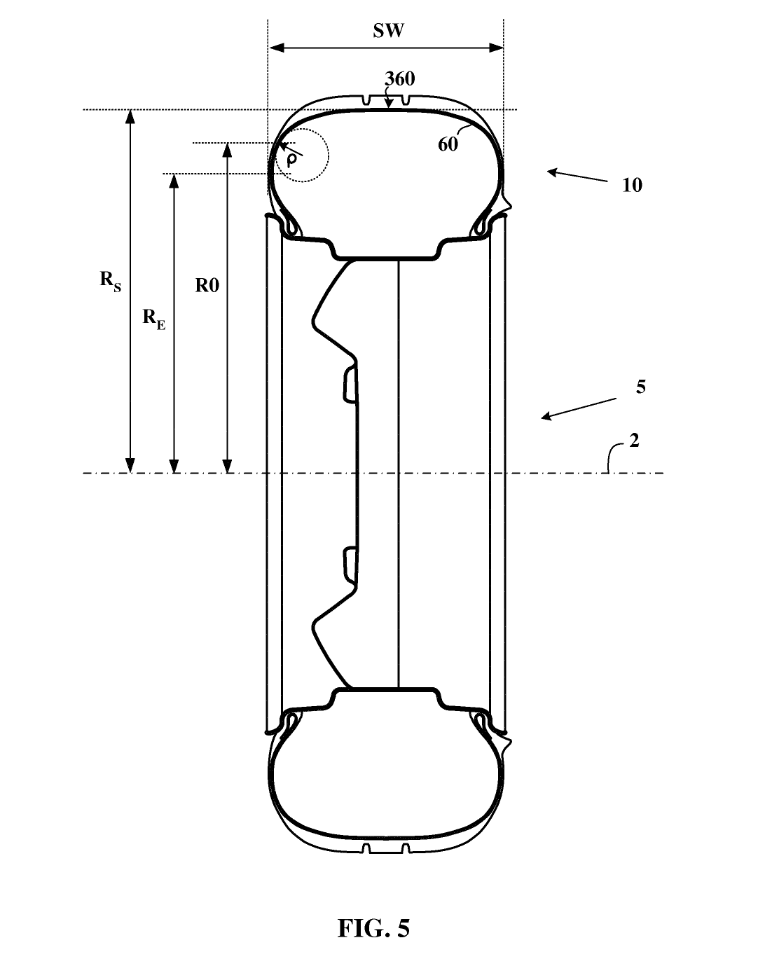

Finally, at any point on the carcass reinforcement 60, the radius of curvature ρ is such that

$$ρ = \frac{{R}_{S}^{2} - {R}_{E}^{2}}{2 R} ,$$

where R_{S} is the radial distance between the rotation axis of the tire and the radially outermost point 360 of the carcass reinforcement 60, R_{E} is the radial distance between the rotation axis of the tire and the axial position where the tire reaches its maximum axial width SR, and R is the radial distance between the rotation axis of the tire and the point in question on the carcass reinforcement. These values are indicated in FIG. 5, together with the radius of curvature ρ for a radial position R=R0. The reference 2 indicates here the rotation axis of the tire 10.

As is well known to those skilled in the art, the latter criterion corresponds to the equilibrium condition for an inflated radial carcass reinforcement. It serves in particular to differentiate the invention from fortuitous prior art representing uninflated tires for which some of the criteria listed above would be fulfilled in the uninflated state, but which would no longer be fulfilled if the tire were to be inflated and the carcass reinforcement were to be considered in the equilibrium state. An example of this is shown in FIG. 1 of document WO 1999/022952 which shows a tire that is manifestly not in equilibrium, as the fold in the carcass reinforcement close to the ends of the crown reinforcement shows.

Such a tire makes it possible, for a given nominal tire size, when mounted on a given mounting rim, under a given service pressure, to best benefit from the design of the geometry of the tire to lighten it and to reduce its rolling resistance, while still maintaining its main performance characteristics, in particular its loading capacity and its capability of not loosening.

However, the Applicant has found that such a tire may prove to have a certain vulnerability to shocks caused by obstacles that it encounters on a roadway, such as a pothole or a pavement curb.

One of the objectives of embodiments of the tire disclosed herein is to solve this difficulty and to define a tire which, apart from the abovementioned advantages, is more resistant to such shocks.

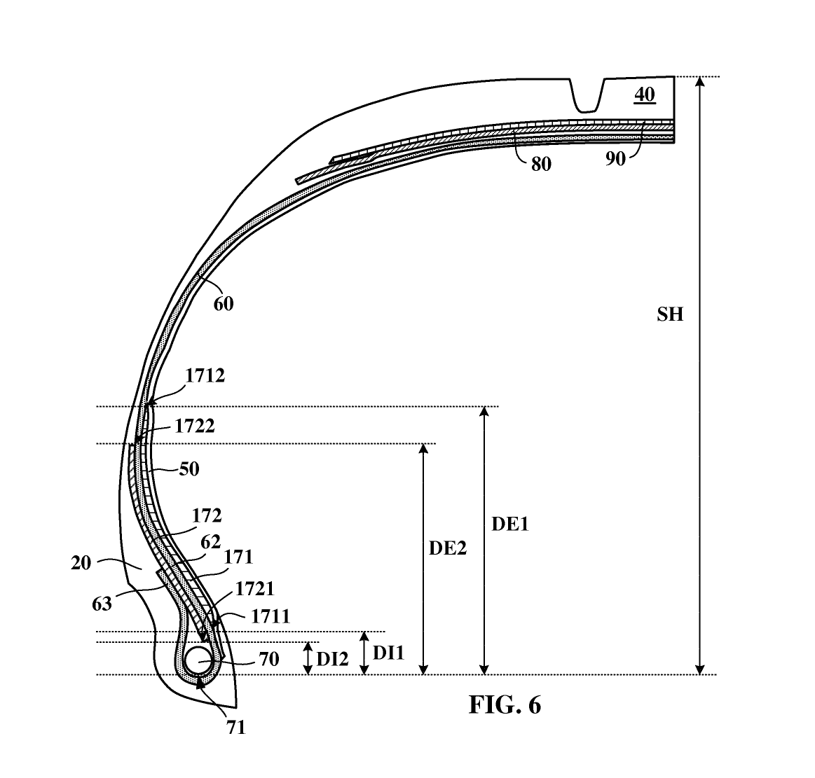

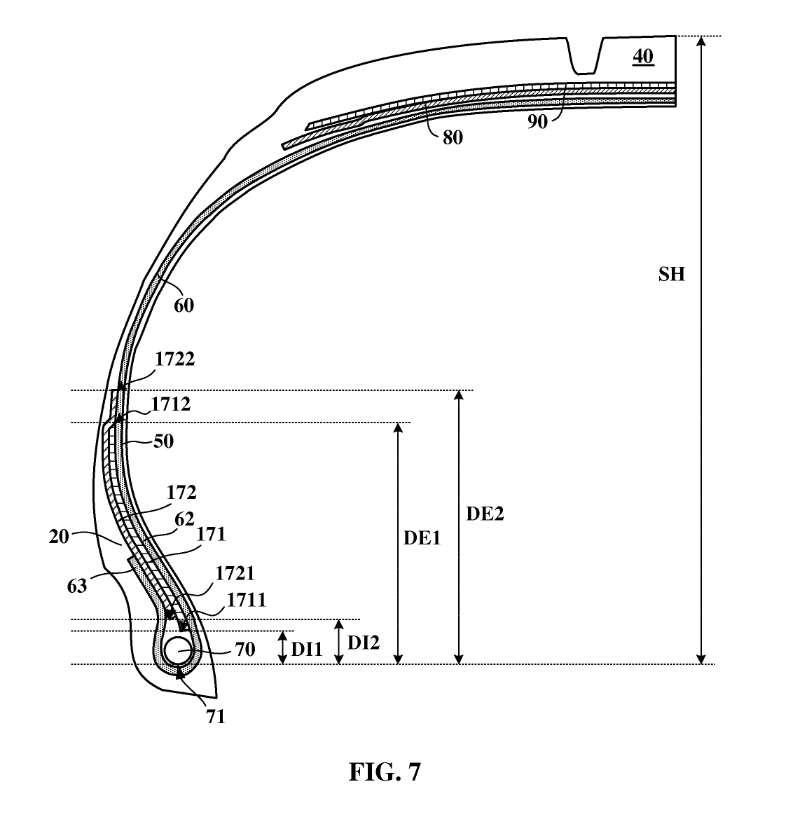

FIGS. 6 and 7 show, in radial section, a portion of one embodiment of a tire according to the invention. The particular feature of such a tire lies in the fact that each sidewall comprises two reinforcing members 171 and 172, each being reinforced by reinforcement elements, in this case parallel filamentary elements. The reinforcing members 171 and 172 are crossed: the reinforcement elements of the first reinforcing member 171 make an angle β (beta) of between 10° and 90° to the circumferential direction and the second reinforcing member 172 makes an angle γ (gamma) of −β. In this case, β=45° and γ=−45°.

In particular embodiments, filamentary reinforcement elements may be made of textile materials such as PET, nylon, rayon, aramid or metal.

In the embodiment shown in FIG. 6, the first reinforcing member 171 and the second reinforcing member 172 extend along the carcass reinforcement 60 between a radially inner end 1711 and 1721 and a radially outer end 1712 and 1722, the radial distance of each of the radially inner ends from the radially innermost point 71 of the annular reinforcing structure 70 being less than 10% of the distance SH and the radial distance of each of the radially outer ends from the radially innermost point 71 of the annular reinforcing structure 70 being greater than 30% of the distance SH. Thus, these reinforcing numbers extend over the entire region that risks becoming jammed between the rim flange and the radially outer portion of the tire. For the tire shown in FIG. 6, DI1/SH=7%, DI2/SH=5%, DE1/SH=45% and DE2/SH=39%.

In the embodiment shown in FIG. 6, the first reinforcing member 171 is placed axially inside the main portion 62 of the carcass reinforcement 60 and the second reinforcing member 172 is placed axially outside the main portion 62 of the carcass reinforcement and, over the height of the wrapped-around portion 63 of the carcass reinforcement 60, axially to the inside thereof.

Another embodiment is shown in FIG. 7. Here, the first reinforcing member 171 and the second reinforcing member 172 are placed axially outside the main portion 62 of the carcass reinforcement and, over the height of the wrapped-around portion 63 of the carcass reinforcement, axially to the inside thereof. For the tire shown in FIG. 7, DI1/SH=5%, DI2/SH=7%, DE1/SH=38% and DE2/SH=44%.

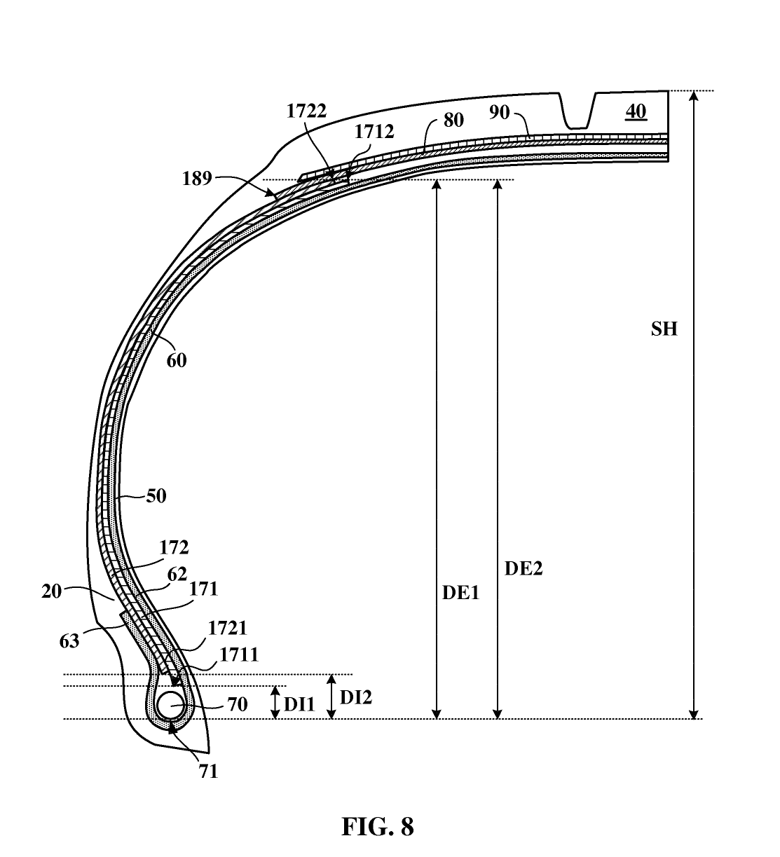

In the tires according to the invention shown in FIGS. 6 and 7, the reinforcing members 171 and 172 do not rise beyond the mid-height of the tire, but while this is illustrative, it is not necessarily required. FIG. 8 shows another tire according to the invention in which these reinforcing members extend radially further to the outside, in this case right to the crown reinforcement formed by the plies 80 and 90. Here, the radial distance of each of the radially outer ends 1712 and 1722 of the reinforcing members 171 and 172 from the radially innermost point 71 is equal to 86% of the distance SH, and the radially outer ends 1712 and 1722 of the reinforcing members 171 and 172 are axially inside the axial end 189 of the crown reinforcement formed by the plies.

Those skilled in the art will understand that the reinforcing members may extend right to the crown, even when one of these reinforcing members is placed axially inside the carcass reinforcement.

A tire according to an embodiment of the invention, of 205/55 R 16 size, corresponding to the embodiment of FIG. 7, was compared with a commercial “Michelin Energy Saver” tire of the same size. The following table gives the essential geometric parameters:

TABLE I

| | | Tire according to |
|---|---|---|
| | Energy Saver tire | the invention |
| TW/RW | 1.07 | 0.83 |
| TW/SW | 0.82 | 0.73 |
| X/SH | 0.53 | 0.50 |
| Y/SH | 0.89 | 0.90 |
| Z/SH | 0.82 | 0.90 |
| α (alpha) | 22 | 22 |

The tire according to an embodiment of the invention is 1.8 kg lighter than the reference tire (weighing 6.2 kg instead of 8.0 kg), but its rolling resistance at 90 km/h is 1.96 kg/T lower and its main performance characteristics are equivalent, in particular its load capacity corresponding to an index of 91 (603 daN) and its ability not to unwedge.

A comparison between this tire according to an embodiment of the invention and a reference tire according to FIG. 4 shows that the tire according to an embodiment of the invention has a much better resistance to the shocks from obstacles on a roadway, for example when it encounters a pothole or a pavement. A reference tire and a tire according to the invention, when inflated to 80% of the ETRTO service pressure and loaded to 80% of the ETRTO load, were made to strike a pavement (height below rim flange +10 mm) at a speed limited to 70 km/h and at an angle of 30° to the straight-line path. It turns out that, unlike the reference tire, the tire according to an embodiment of the invention does not show any fracture of sidewall reinforcement elements, even at the maximum speed.

1. A tire having a rotation axis and comprising:
two beads intended to come into contact with a mounting rim, each bead comprising at least one annular reinforcing structure, defining a mid-plane which is perpendicular to the rotation axis of the tire and located equidistant from the annular reinforcing structures of each bead, the annular reinforcing structures having, in any radial cross section, a radially innermost point;
two sidewalls extending the beads radially outwards, the two sidewalls joining in a crown comprising a crown reinforcement, having two axial ends, said crown reinforcement being surmounted by a tread;
at least one carcass reinforcement extending from the beads through the sidewalls as far as the crown, the carcass reinforcement comprising a plurality of radially oriented carcass reinforcement elements and being anchored in the two beads by an upturn around the annular reinforcing structure, so as to form an main portion and a wrapped-around portion of the carcass reinforcement,
wherein, when the tire is fitted onto the mounting rim and inflated to its service pressure:
the tire has a maximum axial width SW such that the ratio TW/SW≦75%, where TW denotes the axial distance between the two axial ends of the crown reinforcement, the maximum axial width SW being reached at a radial distance X from the radially innermost point of the annular reinforcing structures;
the axial distance RW of the two points of intersection of the axial direction passing through the radially innermost point of the annular reinforcing structures with the external surface of the tire is such that TW/RW≦85%;
the tire satisfies the following three conditions: X/SH≦50%, Y/SH≧80% and Z/SH≧90%, where SH denotes the distance between the radially outermost point of the tire and the radially innermost point of the annular reinforcing structures, Y denotes the radial distance between (i) the points on the carcass reinforcement having the same axial positions as the axial ends of the crown reinforcement and (ii) the radially innermost point of the annular reinforcing structures, and Z denotes the radial distance between the radially outermost point of the carcass reinforcement and the radially innermost point of the annular reinforcing structures;
the absolute value of the angle α (alpha) between the tangent to the carcass reinforcement at the points on the carcass reinforcement having the same axial positions as the axial ends of the crown reinforcement and the axial direction is less than or equal to 22°; and
at any point on the carcass reinforcement, the radius of curvature ρ is such that
$$ρ = \frac{{R}_{S}^{2} - {R}_{E}^{2}}{2 R} ,$$
where RS is the radial distance between the rotation axis of the tire and the radially outermost point of the carcass reinforcement, RE is the radial distance between the rotation axis of the tire and the axial position where the tire reaches its maximum axial width SW, and R is the radial distance between said rotation axis and the point in question on the carcass reinforcement;
wherein each sidewall of the tire comprises a first reinforcing member and a second reinforcing member, the first reinforcing member being reinforced by reinforcement elements placed parallel to one another, making an angle β (beta) of between 10° and 90° with the circumferential direction, the second reinforcing member being reinforced by reinforcement elements parallel to one another, making an angle γ (gamma) of −β with the circumferential direction; and
wherein the first and second reinforcing members extend along the carcass reinforcement, between a radially inner end and a radially outer end, the radial distance (DI1, DI2) of each of the radially inner ends from the radially innermost point of the annular reinforcing structure being less than 10% of the distance SH, and the radial distance (DE1, DE2) of each of the radially outer ends from the radially innermost point of the annular reinforcing structure being greater than 30% of the distance SH.

2. The tire according to claim 1, wherein the ratio TW/SW is less than or equal to 73%.

3. The tire according to claim 1, wherein the ratio TW/RW is less than or equal to 83%.

4. The tire according to claim 1, wherein the first reinforcing member is placed axially inside the main portion of the carcass reinforcement and the second reinforcing member is placed axially outside the main portion of the carcass reinforcement and, over the height of the wrapped-around portion of the carcass reinforcement, axially inside the wrapped-around portion of the carcass reinforcement.

5. The tire according to claim 1, wherein the first and second reinforcing members are placed axially outside the main portion of the carcass reinforcement and, over the height of the wrapped-around portion of the carcass reinforcement, axially inside the wrapped-around portion of the carcass reinforcement.

6. The tire according to claim 1, wherein the radial distance (DE1, DE2) of each of the radially outer ends of the reinforcing members from the radially innermost point of the annular reinforcing structure is greater than 80% of the distance SH.

7. The tire according to claim 6, wherein the radially outer ends of the reinforcing members are axially inside the axial ends of the crown reinforcement.

8. The tire according to claim 1, wherein the reinforcement elements that reinforce said first reinforcing member and second reinforcing member are filamentary reinforcement elements.

9. An assembly formed by a mounting rim and a tire according to claim 1.
